(19) United States
(12) Patent Application Publication
(10) Pub. No.: US 2008/0232115 A1
(43) Pub. Date: Sep. 25, 2008

(54) FOLDABLE LIGHTING SYSTEM

(76) Inventor: Sean Shen Hsun TSAI, Walnut, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/135,037

(22) Filed: Jun. 6, 2008

Related U.S. Application Data
(63) Continuation-in-part of application No. 11/700,595, filed on Jan. 30, 2007, now Pat. No. 7,396,148.

(51) Int. Cl. F21V 15/00

(52) U.S. Cl. 362/362

(57) ABSTRACT

A foldable lighting system may include a light housing having a light source and a top panel, and a foldable lighting device including a first part and a second part pivotally coupled with each other. The foldable lighting system may also include a base panel, a back panel, and two side panels. The back panel may be pivotally coupled to the light housing and foldable relative to the light housing. Each of the two side panels may have at least two sections, a first section pivotally coupled to the light housing, and a second section pivotally coupled to the base panel. The first section and the second section of each of the side panels may be pivotally coupled to each other. The foldable lighting device is placed on the base panel.

### RELATED APPLICATION

This application is a continuation-in-part application of U.S. patent application Ser. No. 11/700,595, entitled “FOLDABLE LIGHTING SYSTEM”, filed Jan. 30, 2007, herein incorporated by reference in its entirety.

### TECHNICAL FIELD

The present disclosure relates generally to a lighting system and more particularly, to a foldable lighting system for providing lighting for photographing.

### BACKGROUND

E-commerce over the Internet has increased significantly over the past few years. Part of e-commerce enables users/customers to buy and/or sell products on online stores. Selling products at online stores often requires users to take photos of their products and upload the photos to the online stores. Currently available consumer digital cameras with photo editing software make it possible for individuals and/or small business owners to take digital photographs of products without the expense or need of a professional photographer.

However, in order to take beautiful photos of photo objects, sufficient and substantially uniform lighting must be provided to the products during photographing. Individuals and/or small business owners often lack the facilities that a photo studio has to provide sufficient and substantially uniform lighting to the photo objects.

One method for providing a studio lighting environment is described in U.S. Pat. No. 7,055,976 (the '976 patent) issued to Blanford. The '976 patent describes a collapsible tabletop lighting apparatus consisting of a box-like structure and a detachable single circular fluorescent lighting unit. Although the system of the '976 patent may provide a lighting system for providing lighting for taking photographs of objects it employs a two-piece design, in which an independent lighting unit is installed on a box-like structure. A user has to assemble the lighting unit onto the box-like structure every time when the user uses the system. Assembling the system is time consuming and inconvenient.

The disclosed system is directed to overcoming one or more of the problems set forth above.

### SUMMARY OF THE INVENTION

In one aspect, the present disclosure is directed to a foldable lighting system. The foldable lighting system may include a light housing including a light source and a top panel. The foldable lighting system may further include a foldable lighting device including a first part and a second part pivotally coupled with each other. The foldable lighting system may also include a base panel, a back panel, and two side panels. The back panel may be pivotally coupled to the light housing and be foldable relative to the light housing. Each of the two side panels may include at least two sections, a first section pivotally coupled to the light housing and a second section pivotally coupled to the base panel. The first section and the second section of each of the side panels are pivotally coupled to each other. The foldable lighting device is placed on the base panel.

### BRIEF DESCRIPTION OF THE DRAWINGS

FIG. 1 is a perspective view of a foldable lighting system in a working mode according to one exemplary embodiment of the disclosure;

FIG. 2 is a perspective view of a compact fluorescent lighting source used with the foldable lighting system of FIG. 1 according to one exemplary embodiment of the disclosure;

FIG. 3 is a perspective view of the foldable lighting system of FIG. 1 with legs according to one exemplary embodiment of the disclosure;

FIG. 4 is a perspective view of the foldable lighting system of FIG. 1 showing a back panel being partially folded in a conversion process a working mode and a folded mode;

FIG. 5 is a perspective view of the foldable lighting system of FIG. 1 showing side panels being partially folded in the conversion process between the working mode and the folded mode;

FIG. 6 is a perspective view of the foldable lighting system of FIG. 1 in the folded mode;

FIG. 7 is a flow chart illustrating a folding process according to an exemplary embodiment of the present disclosure;

FIG. 8 is a foldable lighting system according to one exemplary embodiment of the present disclosure;

FIG. 9A shows a side view of an exemplary foldable lighting device in an open mode;

FIG. 9B shows a side view of the exemplary foldable lighting device in a closed mode; and

FIG. 9C shows a perspective view of the foldable lighting device in the closed mode.

### DETAILED DESCRIPTION

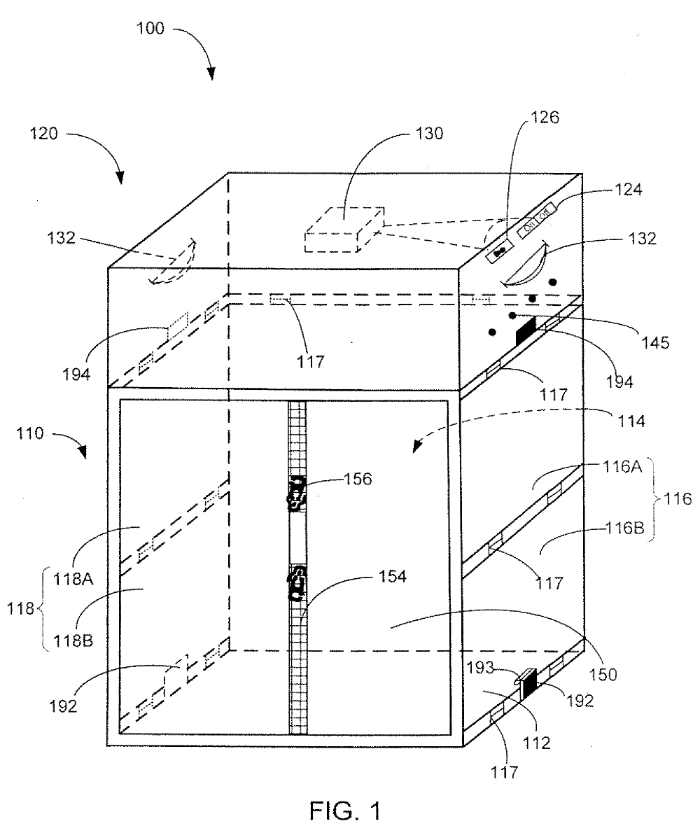

FIG. 1 illustrates an exemplary foldable lighting system 100 in a working mode according to one exemplary embodiment of the present disclosure. In the exemplary embodiment depicted in FIG. 1, the foldable lighting system 100 may include a box structure 110 and a light housing 120. The light housing 120 may be supported by the box structure 110. The box structure 110 may serve as a tent within which an object may be placed for photo shooting. The light housing 120 and the box structure 110 may be manufactured as an integral unit. Alternatively, the light housing 120 and the box structure 110 may be manufactured as separate units and are installed together. The lighting system 100 may provide uniform lighting to the photo object placed in the box structure 110 for photo shooting.

The box structure 110 may include a base panel 112, a back panel 114, and two side panels 116 and 118. The side panel 116 may include at least two sections, a first (upper) section 116A and a second (lower) section 116B. The upper section 116A and the lower section 116B may be pivotally coupled to each other, for example, by hinges 117. Similarly, the side panel 118 may include an upper section 118A and a lower section 118B pivotally coupled to each other, for example, by hinges 117. In one exemplary embodiment, the upper sections 116A and 118A may be pivotally coupled to the light housing 120, for example, by hinges 117. The lower sections 116B and 118B may be pivotally coupled to the base panel 112, for example, by hinges 117. In one exemplary embodiment, the back panel 114 may be pivotally coupled to the light housing 120, for example through hinges 117. In another embodiment (not shown), the back panel 114 may be pivotally coupled to the base panel 112.

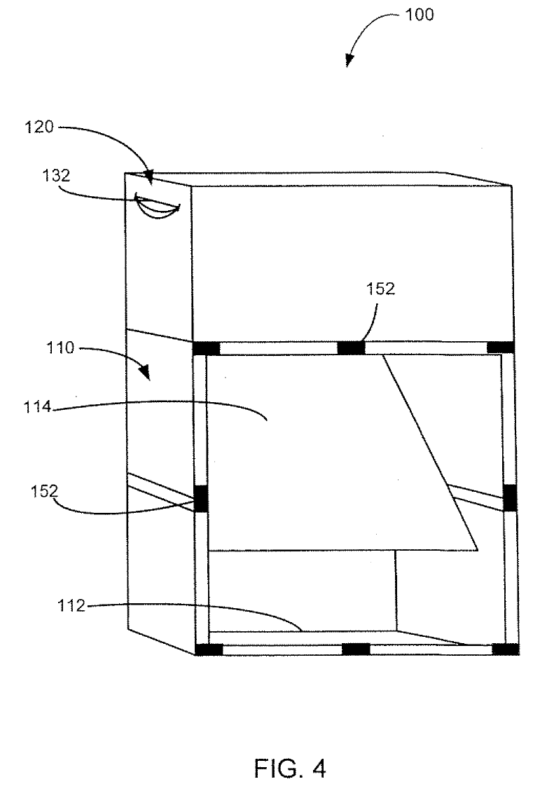

As shown in FIG. 1, the box structure 110 may further include a front cover 150. In one exemplary embodiment, the front cover 150 may be removably attached to a front face of the box structure 110. In one exemplary embodiment, the front cover 150 may be removably attached to the box structure 110 by hook and loop fasteners 152 as shown in FIG. 4. The hook and loop fasteners 152 have one of a loop or a hook surface section attached to the box structure as shown in FIG. 4, and the other surface section attached to the front cover 150. A person skilled in the art should appreciate that other fasteners may be used to attach the front cover 150 to the box structure 110. The front cover 150 may include a selectively operable closure assembly 154. In one exemplary embodiment, as shown in FIG. 1, the selectively operable closure assembly 154 may be a zipper 154 having one or more zip heads 156. The zipper 154 may be configured to open and close the front cover 150 based upon a need to completely close the foldable lighting system 100 for shooting highly reflective items. In one exemplary embodiment, the zipper 154 may have double zipper heads 156 and may be configured to enclose the front cover around a camera lens. In one exemplary embodiment, the front cover 150 may have a white color and be made from vinyl.

In one exemplary embodiment, the light housing 120 and the box structure 110 may be manufactured as separate units and are installed together. The light housing 120 may be pivotally coupled to the box structure 110. For example, one bottom edge of the light housing 120 may be hingedly coupled to the box structure 110 such that the light housing 120 can be hingedly opened.

The light housing 120 may further include a pair of handles 132 mounted on two sides of the light housing 120. By lifting the light housing 120 via the handles 132, the back panel 114 will drop to an upright position (as shown in FIG. 4), and the two side panels 116 and 118 will be unfolded to an upright position. The lighting system 110 can be completely converted from a folded mode to a working mode. The process of conversion of the lighting system 100 between the working mode and the folded mode will be described in detail below. Furthermore, a user can carry the foldable lighting system 100 via the handles 132, so as to facilitate transportation of the foldable lighting system 100. In some exemplary embodiments, as shown in FIG. 1 the light housing 120 may further include at least one ventilation hole 145 through side panels of the light housing 120. The ventilation holes 145 may be configured to provide ventilation to the light housing 120.

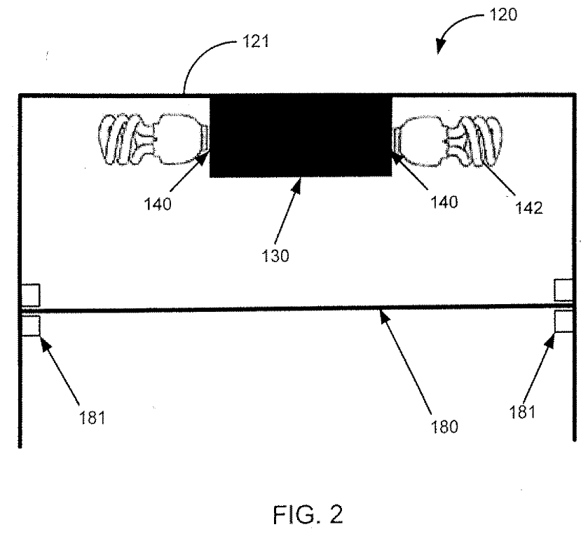

In an exemplary embodiment as depicted in FIGS. 1 and 2, the light housing 120 may include a light source 130. The light source 130 may be any suitable device that can emit light. In some embodiments, the light source 130 may include at least one, for example, two sockets 140. In one exemplary embodiment, the sockets 140 may be mounted on a top panel 121 of the light housing 120. In one exemplary embodiment, the light source 130 may include at least one, for example, two compact fluorescent light bulbs 142 coupled to the sockets 140. In one embodiment, the light source 130 may include a pair of spiral fluorescent light bulbs 142. The light system 130 may include more or less light bulbs in accordance with a need of more or less light in the foldable lighting system 100. A person skilled in the art should appreciate that the light source 130 may use lighting systems other than the compact fluorescent light bulbs 142 to provide lighting for photo shooting.

As shown in FIG. 2, the foldable lighting system 100 may further include a diffusing panel 180 disposed at the bottom of the light housing 120, such that the light housing 120 may provide substantially uniformly diffused lighting onto an object in the box structure 110. In one exemplary embodiment, the diffusing panel 180 may be translucent. In one exemplary embodiment, the diffusing panel 180 may be removably attached to the light housing 120, for example, by hook and loop fasteners or screws. In another exemplary embodiment, the light housing 120 may include sliding channels 181, and the diffusing panel 180 may slide into the sliding channels between the light housing 120 and the box structure 110. In another embodiment, the diffusing panel 180 may be removably attached to the box structure 110. In a further exemplary embodiment, the diffusing panel 180 may be integrated with the light housing 120. In yet another exemplary embodiment, the diffusing panel 180 may be integrated with the box structure 110. The diffusing panel 180 may be embodied as a plastic plate or sheet. Alternatively, the diffusing panel 180 may be embodied as a sheet made from other material or any other suitable device for providing substantially uniformly diffused lighting through the diffusing panel to an object in the box structure 110.

As shown in FIG. 1, the light source 130 may include a switch 124 to control on/off of the light source 130. The light source 130 may further include a power plug 126 for connecting the light source 110 to a power source. In one exemplary embodiment, the power plug 126 may be a universal power plug that can be used with power sources having 100-240 Volts. In another exemplary embodiment, the lighting system 100 may include a battery as the power source, and the light source 130 may be coupled to the battery power source.

The foldable lighting system 100 may further include a pair of locks 190. The lock 190 may include a clip 192 mounted on the box structure 110, for example, the base panel 112. The clip 192 may include a hook structure 193 extending from the clip 192. The lock 190 may further include a tab 194 mounted on the light housing 120. When the box structure 110 is folded, the hook structure 193 may engage the tab 194 and lock the light housing 120 and the folded box structure 110 together. A force applied in a radial and outward direction to be clip 192 may disengage the hook structure 193 from the tab 194 to unlock the folded box structure 110 from the light housing 120.

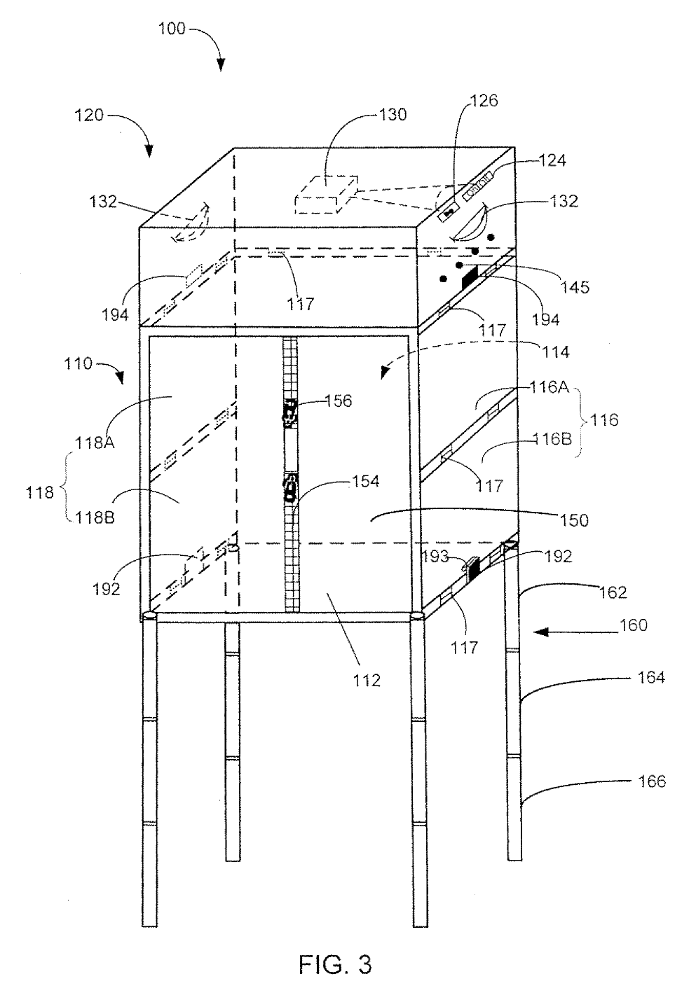

As show in FIG. 3, the box structure 110 may further include legs 160 attached to the base panel 112 of the box structure 110 for supporting the box structure 110. In one embodiment, the legs 160 may be removably attached to the box structure 110, for example, by screw threads. In one exemplary embodiment, the legs 160 may each include a plurality sections removably coupled to each other. In one exemplary embodiment, each of the legs 160 may include three sections 162, 164 and 166. The sections 162, 164 and 166 may be removably coupled to each by screw threads. A person skilled in the art should understand that the legs 160 may be embodied in other types of supporting structures. For example, the legs 160 may be pivotally coupled to the base panel 112, and can be folded and received underneath the base panel 112.

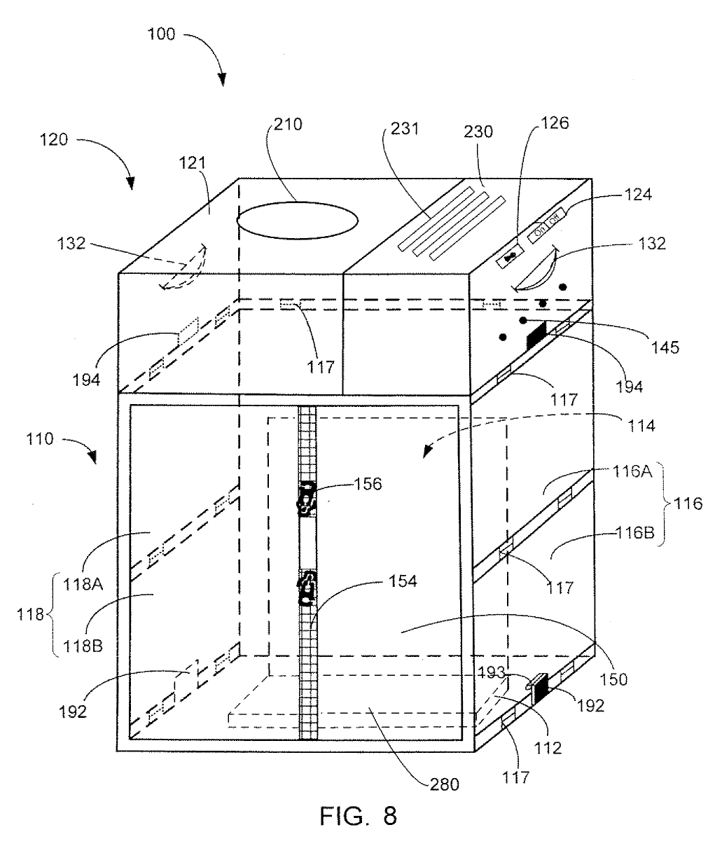

FIG. 8 illustrates an exemplary foldable lighting system according to an embodiment of the present disclosure. As shown in FIG. 8, the upper portion of the light housing 120 may include a top panel 121 having a hole 210. The hole 210 is a through hole, and may be located at any suitable location on the top panel 121, for example, at a center location or a side location on the top panel 121. The hole 210 may have any suitable shape for a camera or lens of a camera to be positioned, for example, a circle, a square, etc. In some embodiments, the hole 210 may be covered by a removable cover, for example, a cover with a closure assembly (e.g., a zipper.)

The foldable lighting system 100 may include a light source 230, which may be any suitable device that can emit light. In some embodiments, the light source 230 may be similar to the light source 130 shown in FIGS. 1 and 2. For example, the light source 230 may include at least one socket (not shown), which may be similar to sockets 140 shown in FIG. 2. The light source 230 may include at least one light bulb 231 which can be any suitable type, for example, incandescent, fluorescent, halogen, light-emitting-diode (LED), high-intensity-discharge (HID), etc. In one exemplary embodiment, the light bulb 231 may be a linear (tube style) fluorescent bulb, or a compact fluorescent bulb. The at least one light bulb 231 may be coupled to the at least one socket. The light source 230 may be located at a suitable location under the top panel 121, for example, a center location or a side location of the top panel 121, or an off-center location. The light source 230 may be adjacent to a switch 124, as shown in FIG. 8. Although one light source 230 is shown in FIG. 8, it is contemplated that more light sources similar to the light source 230 may be included in the foldable lighting system 100. In an embodiment, a fluorescent bulb may be used as the light bulb 231. The fluorescent light source 230 may be located at any suitable locations on the light housing 120, for example, one the top panel of the light housing 120. The fluorescent light source 230 may be connected to an external fluorescent ballast.

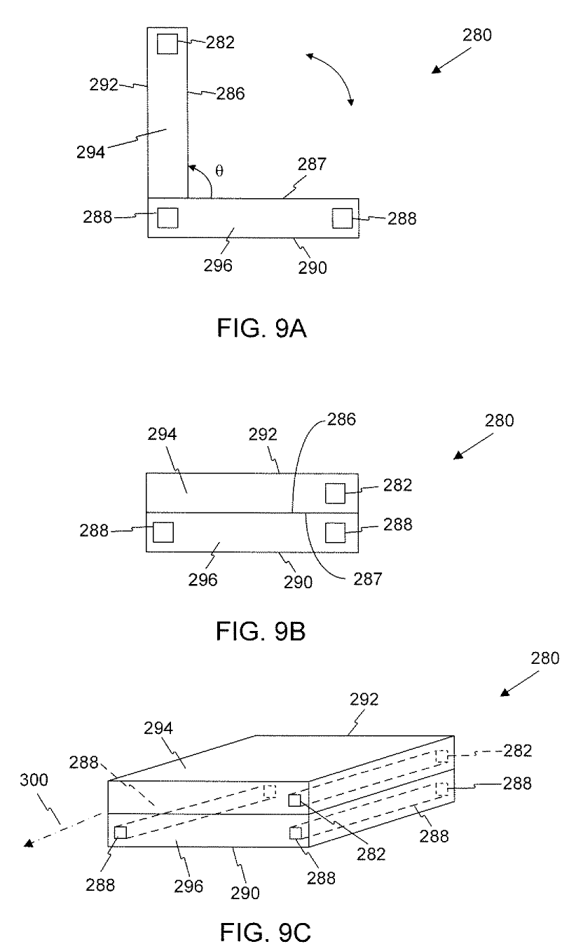

According to another exemplary embodiment, the foldable lighting system 100 may include a foldable lighting device 280, which may be located on the base panel 112. As illustrated in FIG. 8, the foldable lighting device 280 is operated in an open mode, which will be discussed in detail below. In one embodiment, the foldable lighting device 280 may be placed on the base panel 112. The foldable lighting device 280 may be removably attached to base panel 112, or may be fixed or integrated with the base panel 112. In some other embodiments, the foldable lighting device 280 may be attached to the base panel 112 through any suitable fixtures, for example, fasteners, screws, clamps, etc. The foldable lighting device 280 may be removed from the base panel 112 and taken out of the box structure 110. For example, when the closure assembly 154 is opened, the foldable lighting device 280 may be removed from the front. The detailed structure of the foldable lighting device 280 will be discussed in FIGS. 9A, 9B, and 9C.

FIG. 9A shows a side view of an exemplary foldable lighting device 280 in an open mode. FIG. 9B shows a side view of the exemplary foldable lighting device 280 in a closed mode. FIG. 9C shows a perspective view of the foldable lighting device 280 in the closed mode. As shown in FIGS. 9A, 9B, and 9C, the foldable lighting device 280 may include a first part 290 and a second part 292 pivotally coupled with each other. Each one of the first part 290 and the second part 292 may have a box-shape body. Each of the first part 290 and the second part 292 may include a space (spaces 296 and 294, respectively). At least one of the first part 290 and the second parts 292 may be rotatable with respect to a rotation axis 300 (shown in FIG. 9C) so that the foldable lighting device 280 can be opened and closed, as illustrated in FIGS. 9A and 9B.

The first part 290 may include a first surface 287, which may be substantially flat. The second part 292 may include a second surface 286, which may also be substantially flat. When at least one of the first and second parts (290 and 292) is rotated, an angle θ may be formed between the first surface 287 of the first part 290 and the second surface 286 of the second part 292. The angle θ between the first part 290 and the second part 292 may be any suitable angle within a predetermined range, for example, 0°-180°. When the angle is substantially 0°, the foldable lighting device 280 is in a closed mode (closed, or folded). When the angle is substantially 90°, the first surface 287 and the second surface 286 may be substantially in perpendicular planes. That is, the first flat surface 287 may be substantially perpendicular with the second flat surface 286. When the angle is substantially 180°, the first surface 287 and the second surface 286 may be substantially in the same geometrical plane. That is, the first flat surface 287 may be substantially parallel with the second flat surface 286. In one embodiment, the axle or hinge between the first part 290 and the second part 292 may have sufficient friction or employ other mechanism such that the second part 292 can be rotated to any position and stay at that position. In other words, the second part 292 can be rotated to any angle between 0 and 180 degrees and stay at that angle with respect to the first part 290.

Both of the first part 290 and the second part 292 may have suitable shapes, for example, circular shapes, cubic shapes, etc. FIG. 9C illustrates exemplary cubic shaped first part 290 and second part 292. The first surface 287 of the first part 290 and the second surface 286 of the second part 292 may be made of any suitable material that allows light to at least partially pass through. In an exemplary embodiment, the first surface 287 and the second surface 286 may be made of a transparent or translucent material, for example, glass or plastic. In some exemplary embodiments, the first and second surfaces 286, 287 may be diffusing panels to provide substantially uniformly diffused light.

The foldable lighting device 280 may include a plurality of light sources 282 and 288, which may be similar to the light source 130 shown in FIG. 1 and the light source 230 shown in FIG. 8. The plurality of light sources may include, e.g., fluorescent light bulbs. The light sources 288 may be installed inside the space 296 of the first part 290 and the light source 282 may be installed inside the space 294 of the second part 292. As shown in FIG. 9A, at least one light source may be installed in each of the first part 290 and the second part 292. The lighting device 280 may also include sockets to couple the light sources with a power source, such as an external power line, or a battery.

### INDUSTRIAL APPLICABILITY

The disclosed foldable lighting system 100 may be applicable for shooting photos of an object in any working environment that includes indoors and outdoors. The disclosed foldable lighting system may be foldable and portable, and may provide substantially uniform light for photo shooting.

FIGS. 4-6 show how the foldable lighting system 100 being converted between a working mode and a folded mode. As shown in FIG. 4, in one exemplary embodiment, a user may hold the foldable lighting system 100 by holding the pair of handles 132 of the light housing 120 during the opening/folding processes.

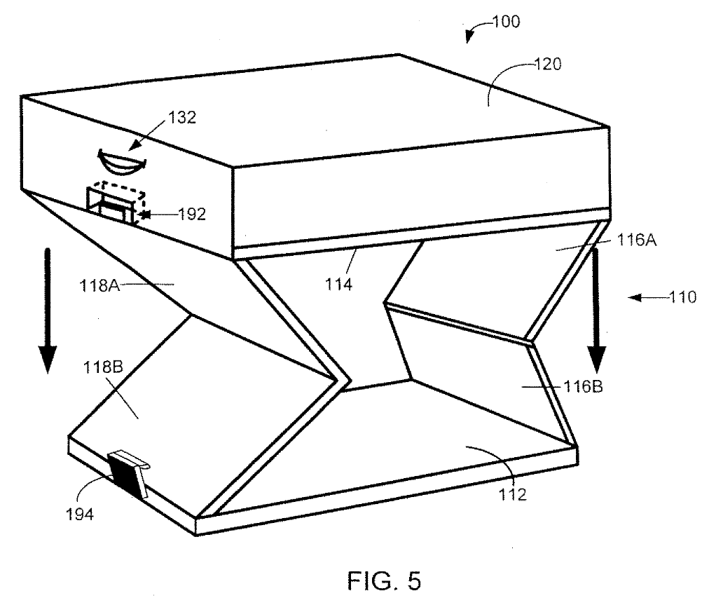

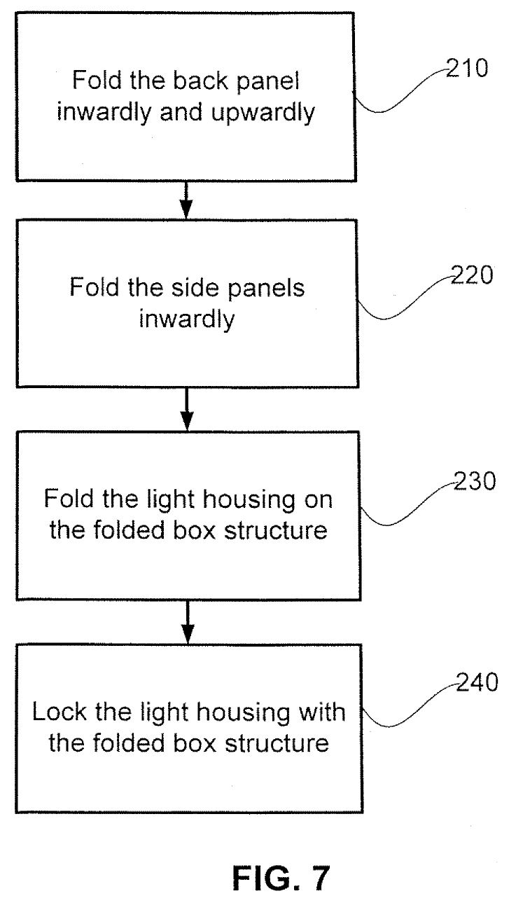

FIG. 7 shows a flow chart of a process of folding the lighting system 100 from the working mode to the folded mode. At step 210, the back panel 114 may be folded inwardly and upwardly relative to the light housing 120 via a pivot connection (for example, hinges 117 as shown in FIG. 1) between the back panel 114 and the light housing 120. At step 220 as shown in FIG. 5, the upper sections 116A and 118A of the side panels 116 and 118 may be folded inwardly relative to the light housing 120 via pivot connections between the upper sections 116A and 118A and the light housing 120. The lower sections 116B and 118B of the side panels 116 and 118 may be folded inwardly relative to the base panel 112 via pivot connections between the lower sections 116B and 118B and the base panel 112. At the same time, the upper sections 116A and 118A and the lower sections 116B and 118B are folded toward each other via pivot connections between the upper sections 116A and 118A and the lower sections 116B and 118B.

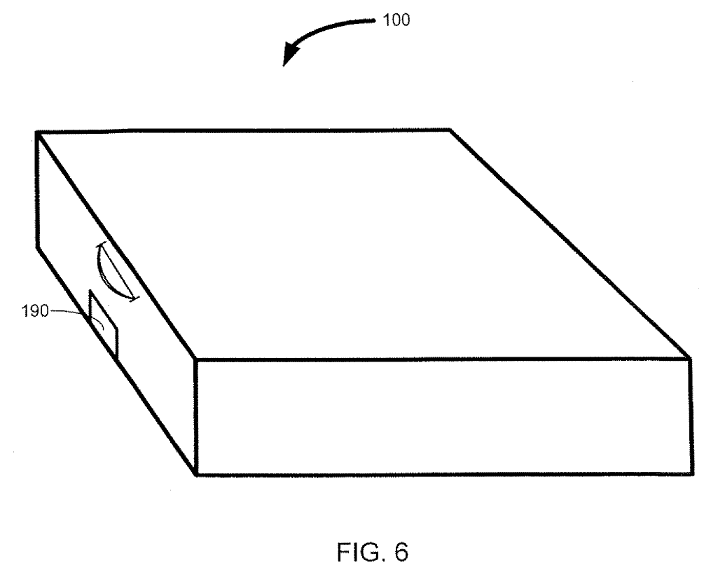

At step 230, after the side panels 116 and 118 are folded on the base panel 112, the folded back panel 114 with the light housing 120 lie over the folded side panels 116 and 118 and the base panel 112. At step 240, the folded box structure 110 is locked together with the light housing 120 by the locks 190, such that the folded light system 100 can be easily transported. FIG. 6 is a perspective view of the foldable lighting system 100 in a fully folded mode.

Referring to FIGS. 8 and 9, before photographing an object, such as a jewelry, the object may be placed on the base panel 112, as discussed above. When the foldable lighting device 280 is put in the box structure 110 and opened so that a suitable angle θ is formed between the first part 290 and the second part 292, the object may be placed, for example, on the first surface 287 of the first part 290. At least one of the light sources 282 and 288 may be turned on to provide light from the back and/or the bottom to illuminate the object to be photographed. The angle may be adjusted by rotating the first part 290 or the second part 292 such that best illumination effect may be provided to the object. Depending on the demands of light for photographing the object, all light sources 230, 282, and 288 may be turned on during the photographing process. Use of the foldable lighting device 280 may provide better illumination of the object, thereby enhancing the photographing quality.

When photographing the object, a photographer (i.e., a user of the foldable lighting system 100) may place a camera (not shown) adjacent to the hole 210 on the top panel 121. The photographer may place the camera above or through the hole, and may extend the camera lens into the space enclosed by the box structure 110 under the hole 210. The photographer may point the camera at the object placed on the base panel 112 or the foldable lighting device 280, and take photos. After photographing is completed, the foldable lighting device 280 may be closed by rotating the second part 292 so that the angle θ between the second part 292 and the first part 290 is substantially 0°, as illustrated in FIG. 9B.

Several advantages over the prior art may be associated with the disclosed portable and foldable lighting system. The lighting system can be completely folded to a relatively small box structure, and that makes it easy to be carried to different locations. The foldable lighting system can be easily converted from a folded mode to a working mode by lifting the handles of the foldable lighting system. The foldable lighting system can be placed in an upright position with the object placed on the base panel, and a photographer can shoot photos of the object from the front or side of the object. The foldable lighting system may also be placed with the front opening facing upward, having the object placed on the back panel, and a photographer can shoot photos of the object from the top of the object. The front cover with double zipper heads can completely enclose the foldable lighting system for shooting highly reflective items. The removably connected supporting legs can fit a user's need when there is no other support on which the foldable lighting system can be put on. The universal power plug can be used for power sources with 100-240 volts, thus the foldable lighting system can be used in different regions. The lighting system 100 may enable better photographing quality through the use of the foldable lighting device.

It will be apparent to those skilled in the art that various modifications and variations can be made to the foldable lighting system. Other embodiments will be apparent to those skilled in the art from consideration of the specification and practice of the disclosed foldable lighting system. It is intended that the specification and examples be considered as exemplary only, with a true scope being indicated by the following claims and their equivalents.

What is claimed is:

1. A foldable lighting system comprising:
a light housing including a light source and a top panel;
a foldable lighting device including a first part and a second part pivotally coupled to the first part;
a base panel, a back panel, and two side panels, the back panel being pivotally coupled to the light housing and being foldable relative to the light housing, each of the two side panels having at least two sections, the at least two sections including a first section pivotally coupled to the light housing, and a second section pivotally coupled to the base panel, wherein the first section and the second section of each of the side panels are pivotally coupled to each other; and
wherein the foldable lighting device is placed on the base panel.

2. The foldable lighting system of claim 1, wherein the first part of the foldable lighting device is rotatable with respect to the second part of the foldable lighting device.

3. The foldable lighting system of claim 1, further including a front cover attached to a front face of the foldable lighting system, wherein the front cover includes a selectively operable closure assembly.

4. The foldable lighting system of claim 1, wherein the foldable lighting device further includes a plurality of light sources.

5. The foldable lighting system of claim 1, wherein the first part of the foldable lighting device includes at least one light source and a diffusing panel.

6. The foldable lighting system of claim 1, wherein the second part of the foldable lighting device includes at least one light source and a diffusing panel.

7. The foldable lighting system of claim 1, wherein the foldable lighting device is removably attached to the base panel of the foldable lighting system.

8. The foldable lighting system of claim 1, wherein the top panel having a hole.

9. The foldable lighting system of claim 1, wherein the first part of the foldable lighting device includes at least one light source and a substantially flat surface made of a material that allows light to at least partially pass through.

10. The foldable lighting system of claim 1, wherein the second part of the foldable lighting device includes at least one light source and a substantially flat surface made of a material that allows light to at least partially pass through.

11. The foldable lighting system of claim 1, wherein the first part of the foldable lighting device is rotatable about an axle which allows the second part to stay at any angle between 0 and 180 degrees with respect to the first part.

12. The foldable lighting system of claim 1 further including legs removably attached to the base panel for supporting the base panel.

13. The foldable lighting system of claim 12, wherein the legs each include a plurality of sections removably coupled to each other.

14. The foldable lighting system of claim 1, further including a lock to lock the light housing with the base panel after the foldable lighting system is folded.

15. The foldable lighting system of claim 1, wherein the light housing includes at least one ventilation hole.

16. The foldable lighting system of claim 1, further including a diffusing panel disposed at a bottom of the light housing, such that the light housing provides substantially uniformly diffused lighting through the diffusing panel.

17. The foldable lighting system of claim 16, wherein the diffusing panel is removably attached to the bottom of the light housing.

18. The foldable lighting system of claim 16, wherein the light housing includes a pair of sliding channels for receiving the diffusing panel, and the diffusing panel is slidably received in the sliding channels.

19. The foldable lighting system of claim 1, wherein the light housing and the foldable lighting device form an integral unit.

20. The foldable lighting system of claim 1, wherein the light source includes at least one compact fluorescent light bulb.
